(19) United States
(12) Patent Application Publication
(10) Pub. No.: US 2017/0318093 A1
(43) Pub. Date: Nov. 2, 2017

(54) Method and System for Focused Storage Access Notifications from a Network Storage System

(71) Applicant: NetApp, Inc., Sunnyvale, CA (US)

(72) Inventors: Mark Muhlestein, Sunnyvale, CA (US); Chinmoy Dey, Bangalore (IN)

(21) Appl. No.: 15/142,305

(22) Filed: Apr. 29, 2016

(51) Int. Cl. H04L 29/08; H04L 12/24

(52) U.S. Cl. CPC H04L 67/1097; H04L 41/06; H04L 67/06

(57) ABSTRACT

Systems, devices, methods, and computer program products are provided for implementing customizable notification filters within a storage system to fine tune the types of storage access notifications that are transmitted to external computing agents. A storage system receives a set of notification rules from a partner computing system. The set of notification rules define a notification filter that specify which of a plurality of storage access requests from one or more client computing devices to forward to the partner computing system. The storage system stores the notification filter within a notification filter repository accessible by the storage system. Upon receiving a storage access request from an external client computing system, the storage system compares the storage access request against the notification filter to transmit a notification regarding the storage access request to the partner computing system or allow the storage access request without requiring transmission of notification.

### TECHNICAL FIELD

The present disclosure relates generally to storage systems and more specifically to a technique for providing, by a storage system, focused storage access notifications to an external agent computing system through the use of dynamic notification filters.

### BACKGROUND

Business entities and consumers are storing an ever increasing amount of digital data. For example, many commercial entities are in the process of digitizing their business records and other data, for example by hosting large amounts of data on web servers, file servers, and other databases. Techniques and mechanisms that facilitate efficient and cost effective storage of vast amounts of digital data are being implemented in storage systems. A storage system can be connected to and host multiple storage devices multiple storage devices, such as physical hard disk drives, solid state drives, networked disk drives, as well as other storage media. Client computing systems can connect to the storage system to access and manipulate files on the multiple storage devices. Partner computing systems operated by third party partners specify storage access policies specify storage access policies that define the scope of allowable file access by the client computing systems. For example, partner computing systems may include administrative computing servers of a business organization that manages a storage system to offer networked storage capabilities to users (e.g., employees or subscribers of the networked storage) of client computing devices. The partner computing system may control storage access policies for individual client computing devices or users of the client computing devices (e.g., when the partner computing system is an administrative server for employees of an organization). In another example, the partner computing system may include a business entity that manages a storage system to offer data content on an on-demand basis to numerous client computing devices that are not controlled by the business entity

Whenever a client computing system requests access to storage hosted by the storage system, the storage system transmits notifications of the client access requests using a file system notification framework. Based on the received file system notifications, the third party partners can determine whether to allow the storage access request or block the storage access request.

However, the current storage access notification framework can result in transmitting numerous storage access notifications to the partner computing system. With an increasing number of instances of client access to data hosted by the storage system, the number of event notifications and required processing by the partner computing system increases, causing performance penalties and increased latency for handling storage access requests. For example, whenever a user of a client computing device navigates sub-folders in a file system hosted by the storage system, or whenever the user accesses or modifies a file within a folder, the storage system generates open, close, or modify storage access notifications for the parent folder. If the partner computing system is not implementing any specific file access policy (e.g., to allow or block the file access requests) for the accessed storage resources, the partner computing system receives the extraneous notifications and discards the notifications. The extraneous notifications increase overhead and network latency, reducing overall storage system performance. There is thus a need for an improved storage access notification framework that enables dynamic notification filters that are customizable by the partner computing system.

### BRIEF DESCRIPTION OF THE DRAWINGS

FIG. 1 is a block diagram illustrating an example of a clustered network environment in which multiple storage systems connected over a data fabric provide client computing systems access to hosted storage, according to certain exemplary embodiments.

FIG. 2 is a block diagram illustrating an example data storage system implementing a notification filter module, according to certain exemplary embodiments.

FIG. 3 is an example of a notification rule repository comprising an example notification filter, according to certain exemplary embodiments.

FIG. 4 is an example of a notification rule repository comprising an alternate example of a notification filter, according to certain exemplary embodiments.

FIG. 5 is a flow chart illustrating an example method for implementing a notification filter by a data storage system, according to certain exemplary embodiments.

### DETAILED DESCRIPTION

Certain embodiments provide systems and methods for enabling a storage system to implement customizable notification filters for reducing the number of storage access notifications that are transmitted from the storage system to external computing agents. The external computing agents are referred to herein as partner computing systems, which may be operated by a vendor or network administrator that is interested in specific types of storage access requests from client computing devices. For example, the partner computing system may be interested in receiving notifications whenever a specific client computing device (identified by, for example, an IP address) or a specific user (identified by a user identifier) attempts to access a particular directory or file on storage hosted by the storage system. In another example, the partner computing system may be interested in receiving notifications whenever a minimum threshold of bytes is written to or read from the hosted storage. In some embodiments, the notification comprises forwarding the storage access request received at the storage system to the partner computing system. To receive notifications on only specific types of storage access requests, the partner computing system transmits a set of notification rules to the storage system. The notification rules define a notification filter that specify which types of storage access requests from partner computing systems to forward to the partner computing system.

The storage system includes a notification filter module that can interpret the sequence of notification rules received from the partner computing system and execute the rules to implement the notification filter. For example, when a storage access request is received from an external client system, the storage system executes the sequence of notification rules to determine if the storage access request should be processed by the storage system (i.e. thereby granting the storage access request) or if a notification regarding the storage access request should be transmitted to the partner computing system. The notification regarding the storage access request may include contextual information about the storage access request allowing the partner computing system to determine whether to allow or deny the request. In some embodiments, the storage system forwards the storage access request to the partner computing system as the notification. By implementing a customizable notification filter within the storage system, present embodiments enable the partner computing system to fine tune the types of notifications to receive from the storage system, reducing the number of extraneous notifications that the partner computing system may have otherwise had to process and discard.

Through embodiments herein, the partner computing system can instruct the storage system to implement complex notification filters for precise types of storage access requests. For example, through embodiments described herein, the storage system can implement a notification filter that transmits a notification or forwards storage access requests from client computing devices if the storage access request would result in increasing the amount of stored files of a certain type above a threshold amount (e.g., if the partner computing system is interested in receiving notifications when a client storage access request would result in increasing the amount of .mp3 files stored in the hosted storage to an amount greater than 2 GB). In this example, the sequence of notification rules received at the storage system specify that the partner computing system should be notified if any client storage access results in exceeding the storage threshold of 2 GB of .mp3 files. Upon receiving storage access requests from client computing systems (e.g., upon receiving requests to create or copy .mp3 files into the data storage hosted by the storage system), the storage system executes the notification filter and allows the storage access requests without having to transmit notifications to the partner computing system and without requiring external processing of the storage rules. Once the threshold of 2 GB of .mp3 storage is reached, the storage system transmits a notification or forwards any storage access requests that would result in increasing the stored amount of .mp3 files over the 2 GB threshold to the partner computing system.

By implementing the notification filter within the storage system, overall storage access performance is increased as the majority of storage access requests for the creation or manipulation of files hosted by the storage system is allowed without requiring the storage system to transmit notifications or forward the storage access request to the partner computing system. Embodiments herein thus provide faster storage access for client computing systems and relieve computing processing resources on the partner computing systems.

By implementing the notification filter to transmit notifications regarding specific storage access requests or forward only specific storage access requests to the partner computing system, the partner computing system is able to specify complex notification rules that would otherwise not be possible in a conventional storage system that requires transmission of event notifications on every storage access request. Specifically, the storage system in the disclosed embodiments is able to process notification rules that rely on specific information available only to the storage system—parameters that would not be practical to transmit to the partner computing system. For example, the storage system may maintain sets of user groups, each user group listing multiple user identifiers for users that are members of the respective user groups. Information identifying all of the user groups and the individual user identifiers associated with each user group may be too large to transmit to the partner computing system. Thus, conventional storage systems do not provide for dynamic notification filters that utilize complex rules that are based on large sets of data (such as information on user groups). Through embodiments herein, the storage system can implement a notification filter that allows file access if a user requesting a file is a member of a privileged group and forward the storage access request to the partner computing device if the user requesting the file is not a member of the privileged group.

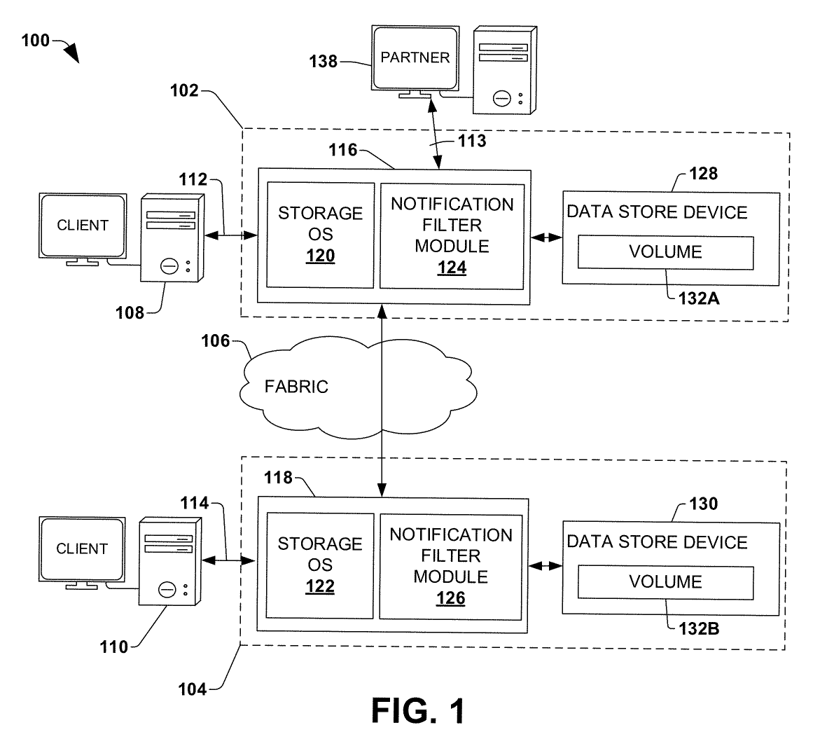

Referring now to the drawings, FIG. 1 is a block diagram illustrating an example of a clustered network environment or a network storage environment 100 that may implement the embodiments and techniques described herein. The example environment 100 comprises data storage systems 102 and 104 that are coupled over a cluster fabric 106, such as a computing network embodied as a private Infiniband or Fibre Channel (FC) network facilitating communication between the storage systems 102 and 104 (and one or more modules, components, etc. therein, such as, storage nodes 116 and 118, for example). While two data storage systems 102 and 104 and two storage nodes 116 and 118 are illustrated in FIG. 1, any suitable number of such components is contemplated. In an example, storage nodes 116, 118 comprise storage controllers (e.g., storage node 116 may comprise a primary or local storage controller and storage node 118 may comprise a secondary or remote storage controller) that provide client devices, such as client computing devices 108, 110 (also referred to as “host devices”), with access to data stored within data storage devices 128, 130. Data storage devices 128, 130 include, for example, disks or arrays of disks, flash memory, flash arrays, and other forms of data storage. Storage nodes 116, 118 communicate with the data storage devices 128, 130 according to a storage area network (SAN) protocol, such as Small Computer System Interface (SCSI) or Fiber Channel Protocol (FCP), for example.

The data stored in various data blocks in data storage devices 128, 130 can be partitioned into one or more volumes 132A-B. In one embodiment, the data storage devices 128, 130 comprise volumes 132A-B, which is an implementation of storage of information onto disk drives or disk arrays or other storage (e.g., flash) as a file-system for data, for example. Volumes can span a portion of a disk, a collection of disks, or portions of disks, for example, and typically define an overall logical arrangement of file storage on disk space in the storage system. In one embodiment a volume can comprise stored data as one or more files that reside in a hierarchical directory structure within the volume. The cluster fabric 106 enables communication between each of the storage systems 102, 104 within the networked storage environment 100, allowing storage nodes 116, 118 to access data on both data storage devices 128, 130.

In the illustrated example, one or more client computing devices 108, 110 which may comprise, for example, personal computers (PCs), computing devices used for storage (e.g., storage servers), and other computers or peripheral devices (e.g., printers), are coupled to the respective data storage systems 102, 104 by storage network connections 112, 114. Similarly, a partner computing system 138 is coupled to a storage node 116 via network connection 113. Network connections may comprise a local area network (LAN) or wide area network (WAN), for example, that utilizes Network Attached Storage (NAS) protocols, such as a Common Internet File System (CIFS) protocol or a Network File System (NFS) protocol to exchange data packets. The client computing devices 108, 110 and partner computing device 138 may be general-purpose computers running applications or computer servers for accessing and managing data storage on data storage devices 128, 130. In some embodiments, client computing devices 102, 104 access data on data storage devices 128, 130 using a client/server model for exchange of information. That is, the client computing device 108, 110 may request data from volumes 132A-B in the data storage system 102, 104 (e.g., by requesting data stored on data storage device 128, 130 managed and hosted by the data storage system 102, 104), and the data storage systems 102, 104 may return results of the request to the client computing device 108, 110 via one or more network connections 112, 114. Each of the client computing devices 108, 110 can be networked with both of the data storage systems 102, 104 in the network cluster 100 via the data fabric 106. For example, a client computing device 108 may request data storage access to manipulate files in data storage device 130 managed by data storage node 118. Storage node 116 provides the communication between client computing device 108 and storage node 118 via data fabric 106.

Storage nodes 116, 118 include various functional components that coordinate to provide client computing devices 108, 110 access to data blocks within data storage devices 128, 130. Storage nodes 116, 118 include, for example, a memory device that can execute program code for performing operations described herein. One or more processors in storage nodes 116, 118 execute program code for implementing storage operating systems 120, 122. The storage operating systems 120, 122 manage data access operations between the client computing devices 108, 110 and the data storage devices 128, 130. For example, the storage operating systems 120, 122 allocate blocks of data across data storage devices 128, 130 and partition the data blocks into the one or more volumes 132A-B and assign the volumes 132A-B to client computing devices 108, 110. The storage nodes 116, 118 also include program code defining notification filter modules 124, 126. One or more processors in the storage nodes 116, 118 execute program code for the notification filter modules 124, 126 to receive and execute the notification filters received from the partner computing system 138. For example, as described in more detail below, the notification filter module 124 receives a sequence of notification rules from the partner computing device 138, the sequence of notification rules defining a specific notification filter. The notification filter module 124 can also verify the notification rules received from the partner computing device 138 adhere to a defined notification rule syntax and store the sequence of notification rules within a notification rule repository. Further, upon receiving a storage access request from a client computing device 108, 110, the notification filter module 124 executes the notification filter to allow access to the requested storage resources transmit a notification of the storage access or forward the storage access request to partner computing device 138. While both data storage systems 102, 104 are shown to include storage nodes 116, 118 with notification filter modules 124, 126, in some embodiments one of the data storage systems (e.g., data storage system 102) may include the notification filter module 124 and handle notification filters for all storage systems 102, 104 in the clustered network environment 100.

While partner computing system 138 is shown as communicating with storage system 102 for illustrative purposes, one or more partner computing systems 138 may also communicate with other storage systems (i.e. storage system 104) in the clustered network environment 100. Further while one partner computing system 138 is shown as communicating with the storage system 102, multiple partner computing systems can communicate with the storage system 102. Each of the storage systems 102, 104 includes a notification filter module 124, 126, allowing sets of notification rules received from the partner computing system 138 to be stored on any of the storage systems 102, 104 in the clustered network environment 100.

While a clustered network environment 100 involving multiple storage systems 102, 104 are shown for exemplary purposes, it should be appreciated that the techniques described herein may also be implemented in a non-cluster network environment involving a single storage system, and/or a variety of other computing environments, such as a desktop computing environment. It will be further appreciated that the data storage systems 102, 104 in clustered network 100 are not limited to any particular geographic areas and can be clustered locally and/or remotely. Thus, in one embodiment a clustered network 100 can be distributed over a plurality of storage systems and/or nodes located in a plurality of geographic locations; while in another embodiment the clustered network 100 includes data storage systems 102, 104 residing in a same geographic location (e.g., in a single onsite rack of data storage devices).

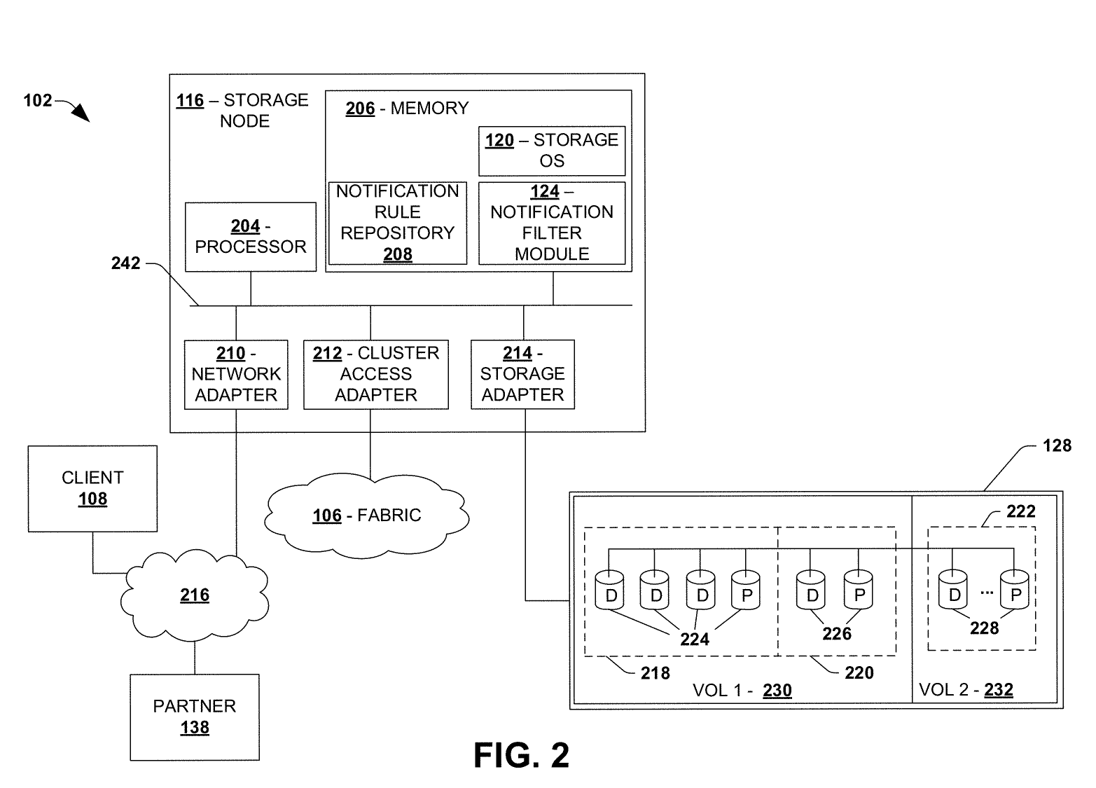

FIG. 2 is an illustrative example of the data storage system 102, providing further detail of an embodiment of components that may implement one or more of the techniques and/or systems described herein. The example data storage system 102 comprises a storage node 116 and a data storage device 128. The storage node 116 may be a general purpose computer, for example, or some other computing device particularly configured to operate as a storage server. A client computing device 108 can be connected to the storage node 116 over a network 216, for example, to provide access to files and/or other data stored on the data storage device 128. In an example, the storage node 116 comprises a storage controller that provides client computing device 108 with access to data stored within data storage device 128. As described with respect to FIG. 1, the storage node 116 may also receive storage access requests from client computing device 110 (not shown in FIG. 2) via data fabric 106. The storage node 116 comprises one or more processors 204, a memory 206 (i.e. a non-transitory computer readable memory), a network adapter 210, a cluster access adapter 212, and a storage adapter 214 interconnected by a system bus 242. The storage node 116 also includes a storage operating system 120 and a notification filter module 124 installed in the memory 206, both described above with reference to FIG. 1.

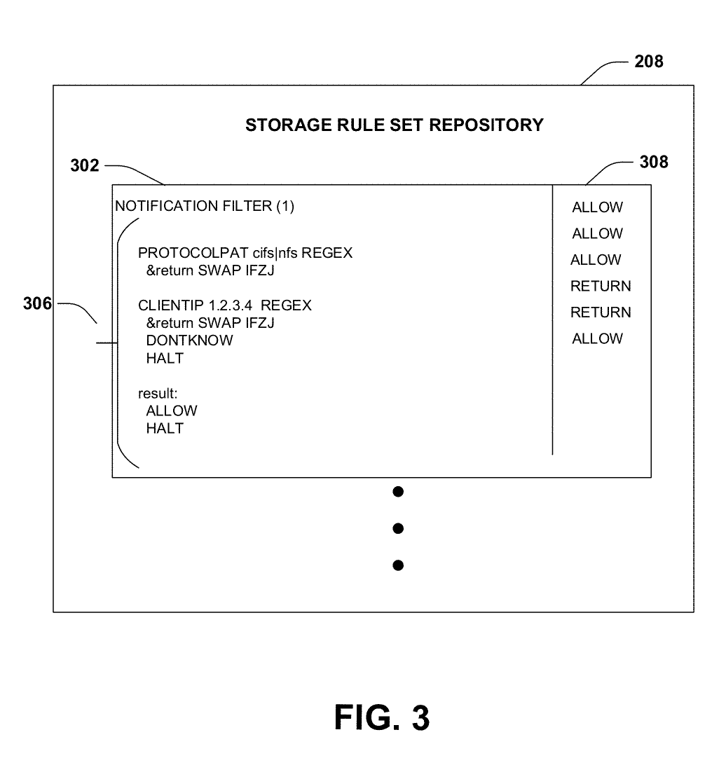

The storage node 116 also includes a notification filter repository 208 stored within the memory 206. The notification filter repository 208 includes a database of stored storage rules received from the partner computing system 138. Upon receiving a storage access request from client computing device 108, the notification filter module 124 executing in the storage node 116 compares the storage access request against sets of notification rules stored in the notification filter repository 208. If the storage access request satisfies the notification rules in a notification filter, the notification filter module 124 transmits a notification to the partner computing device 138 or forwards the storage access request to the partner computing device 138. If the storage access request does not satisfy all of the notification rules, the storage system 102 allows the storage access request or denies the storage access request depending on the specific rules for the notification filter. The storage system allows the storage request by retrieving or manipulating the requested data in data storage device 128 (as described further below). Additionally, the notification filter module 124 stores the result of the storage access request (e.g., whether the request was allowed, denied, or a notification regarding the request was transmitted to the partner computing device 138) within the notification filter repository 208. The results of multiple storage access requests may be stored for example, in notification filter repository 208. An example of a set of notification rules and the corresponding results from subsequent client storage access request is shown in FIG. 3 below. Note that while the notification filter repository 208 is shown as included in the memory 206 of storage system 102, in other embodiments, the notification filter repository 208 may be stored in a storage device remote from the storage system 102 and accessible by the storage system 102.

By storing the data access rules and results of client storage access requests in the non-transitory memory 206, the partner computing system 138 may store multiple notification filters within the storage node 116 in a non-volatile manner, each of the notification filters providing different policies for when storage access requests should be forwarded to the partner computing system 138. As the notification rules are stored in a non-volatile manner, the partner computing system 138 can retrieve a list of the current notification rules and results of any prior client storage access requests from the notification filter repository 208, even after the storage node 116 or storage system 102 reboots.

The processor 204 may comprise a microprocessor, an application-specific integrated circuit (“ASIC”), a state machine, or other processing device. The processor 204 can include any of a number of processing devices, including one. Such a processor 204 can include or may be in communication with a computer-readable medium (e.g. memory 206) storing instructions that, when executed by the processor 204, cause the processor to perform the operations described herein for implementing notification filters to transmit notifications regarding specific storage access requests or forward specific storage access requests to the partner computing system 138.

The memory 206 can be or include any suitable non-transitory computer-readable medium. The computer-readable medium can include any electronic, optical, magnetic, or other storage device capable of providing a processor with computer-readable instructions or other program code. Non-limiting examples of a computer-readable medium include a floppy disk, CD-ROM, DVD, magnetic disk, memory chip, ROM, RAM, an ASIC, a configured processor, optical storage, magnetic tape or other magnetic storage, or any other medium from which a computer processor can read instructions. The program code or instructions may include processor-specific instructions generated by a compiler and/or an interpreter from code written in any suitable computer-programming language, including, for example, C, C++, C#, Visual Basic, Java, Python, Perl, JavaScript, and ActionScript. The storage system 102 can execute program code that configures the processor 204 to perform one or more of the operations described herein.

The data storage device 128 may comprise storage devices, such as disks 224, 226, 228 of a disk array 218, 220, 222. It will be appreciated that the techniques and systems, described herein, are not limited by the example embodiment. For example, disks 224, 226, 228 may comprise any type of mass storage devices, including but not limited to magnetic disk drives, flash memory, and any other similar media adapted to store information, including, for example, data (D) and/or parity (P) information. The storage devices 224, 226, and 228 are organized into one or more volumes 230, 232.

The network adapter 210 includes the mechanical, electrical and signaling circuitry needed to connect the data storage system 200 to the client computing system 108 over a computer network 216, which may comprise, among other things, a point-to-point connection or a shared medium, such as a local area network. The storage adapter 214 cooperates with the storage operating system 120 executing on the storage node 116 to access information requested by the client computing system 108 (e.g., access data on the storage device 128). The storage adapter 214 can include input/output (I/O) interface circuitry that couples to the disks over an I/O interconnect arrangement, such as a storage area network (SAN) protocol (e.g., Small Computer System Interface (SCSI), iSCSI, hyperSCSI, Fibre Channel Protocol (FCP)). The storage information requested by the client computing system 108 is retrieved by the storage adapter 214 and, if necessary, processed by the one or more processors 204 (or the storage adapter 214 itself) prior to being forwarded over the system bus 242 to the network adapter 210 (and/or the cluster access adapter 212 if sending to another node in the cluster) where the information is formatted into a data packet and returned to the client computing device 108 over the network connection 216 (and/or returned to another node attached to the cluster over the cluster fabric 106).

As described above with respect to FIGS. 1 and 2, the partner computing system 138 transmits sets of notification rules to the storage system 102, and the sets of notification rules are stored in a notification filter repository 208. Each set of notification rules defines a particular notification filter for transmitting notifications regarding a specific type of storage access requests or forwarding a specific type of storage access request to the partner computing system 138. FIG. 3 is an example of notification filter repository 208 showing notification 302. For illustrative purposes, one notification filter 302 is shown. However, notification filter repository 302 may include multiple different notification filters received from a partner computing system 138. Each of the notification filters corresponds to a different sequence of computer logic that instructs the storage system 102 when to allow client devices 108, 110 (or users access client devices 108, 110) to perform specific file access operations (i.e. for accessing or otherwise manipulating files in data storage devices 128, 130) and when to transmit notifications or forward requests for said file access operations to the partner computing device 138.

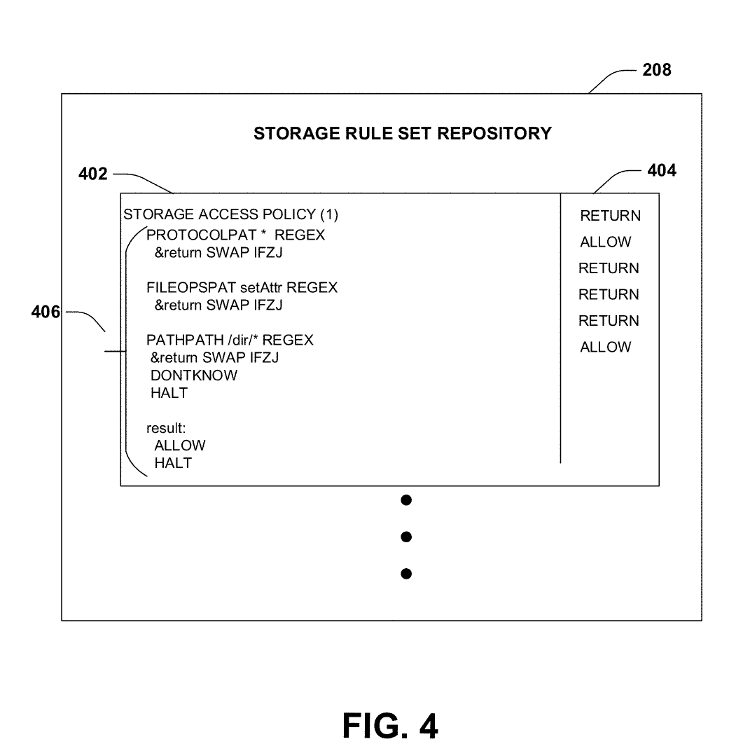

FIGS. 3 and 4 depicts examples of an example of notification filters 302, and 402, respectively. In the examples in FIGS. 3 and 4, the expression “DONTKNOW” corresponds to an instruction to transmit a notification of the storage access request to the partner computing system 138, and the expression “ALLOW” corresponds to an instruction to allow the client access request.

In FIG. 3, the notification filter 302 includes a set notification rules 306 that provide the necessary computer logic in the form of a scripting language. Any suitable computer-readable scripting language or programming language may be used for the set of storage rules. The notification filter 302 specifies that the storage system 102 should transmit a notification when a storage access request includes a specific client IP address, informing the partner computing system 138 that a specific client computing device 108 has attempted access of storage resources. Specifically, the set of notification rules 306 indicate that if a storage access request utilizes the CIFS or NFS storage communication protocols and that the storage access request is from a particular client identifier (identified by an IP address) of client computing device 108, then the storage system 102 should transmit a notification to the partner computing system 138. The notification rules 306 further specify that if the storage access request does not utilize the CIFS or NFS communication protocols or if the storage access request does not include the specific client IP address, then the storage system 102 should allow the storage access request and not transmit any notification of the request to the partner computing system 138.

As described above, results of each execution of the notification filters are also stored in the storage notification filter repository 208. FIG. 3 shows example results 304. The example results 304 depict six different storage access requests, each eliciting execution of the notification filter 302. As shown in the example, the first three storage access requests were allowed, two of the requests resulted in returning notifications to the partner computing system 138, and the last request was allowed. While the example results 304 shown in FIG. 3 depict whether the access requests were allowed or returned, additional data describing details of the storage access requests can also be stored. For example, the storage system 102 may also store, for each storage access request, a User ID of the user of the client computing requesting the access, a user group identifier identifying the user group that the user belongs to, the specific file or directory that was accessed or for which access was attempted, and the specific file access operation that was attempted.

FIG. 4 depicts a second notification filter 402 that specifies that a notification should be transmitted to a partner computing system 138 when the storage access request from a client computing device 108, 110 is for a particular directory and its subdirectories and only when the storage access request is attempting to set attributes within one files or directories. Specifically, the set of notification rules 402 specify that if a storage access request is received on any type of communication protocol, the storage access request is to set an attribute in the file system, and the storage access request is for access of the directory /dir/ and any subdirectories, then the storage system 102 should transmit a notification of the storage access request to the partner computing system 138. If any of the notification rules in notification filter 402 are not satisfied, then no notification is transmitted and the storage system 102 allows the storage access request.

Results of the execution of the notification filter 402 are shown as example results 404. The example results 404 depict results from six different storage access requests, each eliciting execution of the notification filter 402. As shown in the example, the first, third, fourth, and fifth storage access requests resulted in notifications to the partner computing system 138.

The specific notification filters 302 and 402 and example results 304 and 404 are shown for illustrative purposes. The different types of notification filters available in the embodiments herein, however, are not limited. Through embodiments herein, the partner computing system 138 is able to provide complex sets of notification rules defining diverse types of notification filters. For example, one notification filter may specify a sequence of computer logic instructing the storage system 102 to notify the partner computing system 138 if any client computing device 108, 110 attempts to create a prohibited file type. In some embodiments, the set of notification rules defining the notification filter specify which specific users or user groups can perform file access operations in the storage volumes 132A-B.

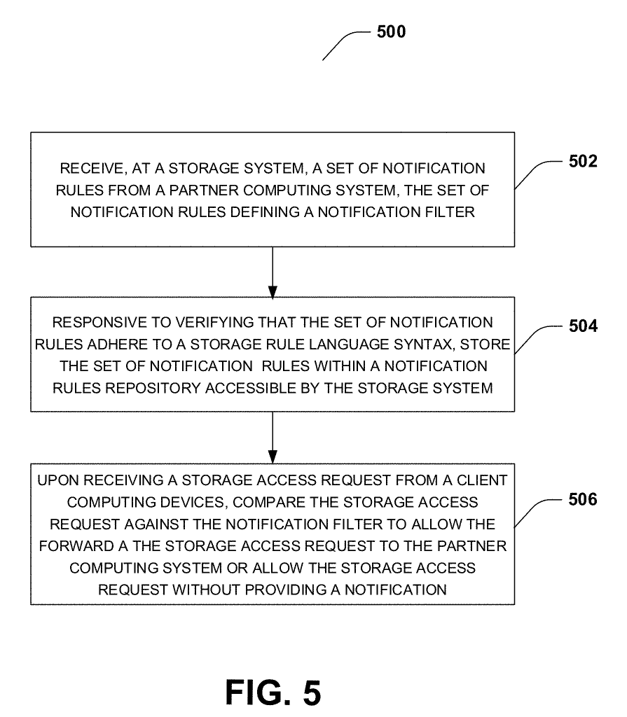

FIG. 5 is a flowchart illustrating an example of a method 500 performed by a storage system 102 for receiving and implementing a notification filter at a client computing device 108. For illustrative purposes, the method 500 is described with reference to the system implementation depicted in FIGS. 1-2. Other implementations, however, are possible.

The method 500 involves receiving, at a storage system, a set of notification rules from a partner computing system, as shown in block 502. The set of notification rules define a notification filter specifying which of a plurality of storage access requests from one or more client computing system to forward to the partner computing system. For example, the storage system 102 receives a communication over a network from the partner computing system 138. The communication includes a set of notification rules that comprise the logic defining a specific notification filter.

The received notification filter can specify various contexts in which storage access requests should be forwarded to the partner computing system 138 as notifications. For example, the notification filter can specify forwarding storage access requests from client computing devices 108, 110 if the storage access requests are for performing one or more specific file operations within a file system (e.g., creating a file, accessing a file, deleting a file, accessing a directory, modifying file attributes, and other operations routinely made available by storage operating system 120. The file system includes files in a hierarchical directory in volumes 132A-B in data storage devices 128, 130. The notification filter can also specify forwarding notifications to partner computing system 138 if specific user identifiers or client computing system identifiers (e.g., IP address) are associated with the storage access request. In additional embodiments, the notification filter can include multiple notification rules as shown in FIGS. 3 and 4, where the storage requests are forwarded to partner computing system 138 only if multiple conditions are met.

Responsive to verifying that the set of notification rules adhere to a storage rule language syntax, the storage system 102 stores the set of notification rules within a notification filter repository accessible by the storage system, as shown in block 504. For example, the notification filter module 124 may be configured to interpret notification rules provided from the partner computing system 138 according to a particular syntax. The required notification rule language syntax may specify parameters or expressions that define the particular scripting language being used to implement the notification filters. To determine if a received set of notification rules adhere to the storage rule language syntax, the storage system 102 compares the received set of notification rules with the parameters and expressions provided in the storage rule language syntax. If the set of notification rules adhere to the storage rule language syntax, the set of notification rules are stored within the notification filter repository 208. If the set of notification rules do not adhere to the storage rule language syntax, a syntax error notification is transmitted back to the partner computing system 138.

In some embodiments, prior to providing the notification filters, the partner computing system 138 can define a particular storage rule language syntax and transmit the storage rule language syntax to the storage system 102. The storage system 102 stores the storage rule language syntax in memory 206. In such embodiments, the partner computing system 138 is able to customize the storage rule language syntax and add additional commands, parameters, and expressions to the syntax, enabling more complex notification rules.

The set of notification rules are stored within the notification filter repository 208 on behalf of the partner computing device 138. This allows the partner computing system 138 to offload the processing for storage access requests to the storage system 102, thus decreasing the number of storage access notifications that are required to be transmitted back to the partner computing system 138.

Upon receiving a storage access request from a client computing device, the storage system 102 compares the storage access request against the notification filter, as shown in block 506. Based on the results of the comparison, the storage system 102 transmits a notification of the storage access request to the partner computing system 138 or allows the storage access request without transmitting a notification. For example, the notification of the storage access request may include contextual details about the storage access request. For example, the notification may include a client computing device identifier (e.g., IP address, MAC address, or other identifier), a user identifier, indication of the file access operation requested (e.g., read from, write to, set attribute for, etc.), and/or the specific directory path and file path requested. The notification may comprise forwarding the storage access request to the partner computing system 138. In some embodiments, the notification filter can instruct the storage system 102 to deny the storage access request under certain conditions without sending any event notification to the partner computing system 138.

For example, a client computing device 108 issues a storage access request to storage system 102. The storage access request is for performing an operation on a resource (e.g., to create, view, open, edit, set attributes for, and other operations on a file or directory) in a file system hosted by the storage system 102. To compare the storage access request against the notification filter, the notification filter module 124 executes the set of notification rules defining the notification filter to determine if the storage access request satisfies the set of notification rules. For example, the storage access request includes information such as the user identifier for the user of client computing device 108 issuing the request, the network protocol (e.g., CIFS, SMB) used, the path name of the specific resource in the request (e.g., the directory and file path a particular file or a directory path for a particular directory being requested), and the type of operation being requested. The notification filter module 124 compares the information in the storage access request with the corresponding expressions in the set of notification rules. Referring back to FIG. 3 as an example, the notification filter module 124 compares the IP address included or associated with the storage access request with the CLINETIP notification rule in notification filter 302. If the user identifier matches the CLIENTIP notification rule, the notification filter module 124 proceeds to the next notification rule. If the user identifier does not match the CLIENTIP storage rule, the notification filter module 124 jumps to the result notification rule, allowing the storage access request.

If the notification filter module 124 determines that the storage access request satisfies all of the set of notification rules, the notification filter module 124 forward the storage access request to the partner computing system 138. The storage system 102 forward the storage access request by, for example, transmitting the storage access request, including any associated information identifying the type of file access operation, client identifier, user identifier, type of communication protocol used, etc. to the partner computing system 138. In some embodiments, instead of forwarding the storage access request, the notification filter module 124 transmits an event notification to the partner computing system 138 indicating that a storage access request satisfying a notification filter was received, and further identifies the notification filter. The storage system 102 stores the result of the storage access request within the notification filter repository 208. By implementing the notification filter, the storage system 102 does not have to transmit notifications of every storage access request to the partner computing system 138.

In some embodiments, the notification filter may include a notification rule instructing the storage system 102 to deny the storage access request if the request does not satisfy all of the set of notification rules. Upon determining that storage access request does not satisfy all of the set of notification rules, the storage system 102, in this example, denies the request without transmitting an event notification to the partner computing system 138.

Embodiments herein also provide for additional functions available to a partner computing system 138 for managing the notification filters and results of storage access requests. For example, in one embodiment, the partner computing system 138 can request results of the storage access requests over a specified period of time. For example, the storage system 102 may receive a request from the partner computing system 138 to retrieve results of previous storage access requests received from client computing devices 108, 110. The request to retrieve the results may also include a specified period of time period. The notification filter module 124 identifies the storage access requests that were received from client computing devices 108, 110 over the specified period of time and transmits the results of the identified storage access requests to the partner computing system 138.

In an additional embodiment, the storage system 102 receives a request from the partner computing system 138 to purge the set of notification rules from the notification filter repository 208. For example, the notification filter module 124 can provide a list of the current notification filters (and the associated sets of notification rules defining said notification filters) to the partner computing system 138. The partner computing system 138 may select one or more of the notification filters for deletion. Upon receiving the request to purge the selected notification filters, the storage system 102 deletes the corresponding notification filters from the notification filter repository 208.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

Some embodiments described herein may be conveniently implemented using a conventional general purpose or a specialized digital computer or microprocessor programmed according to the teachings herein, as will be apparent to those skilled in the computer art. Some embodiments may be implemented by a general purpose computer programmed to perform method or process steps described herein. Such programming may produce a new machine or special purpose computer for performing particular method or process steps and functions (described herein) pursuant to instructions from program software. Appropriate software coding may be prepared by programmers based on the teachings herein, as will be apparent to those skilled in the software art. Some embodiments may also be implemented by the preparation of application-specific integrated circuits or by interconnecting an appropriate network of conventional component circuits, as will be readily apparent to those skilled in the art. Those of skill in the art will understand that information may be represented using any of a variety of different technologies and techniques.

Some embodiments include a computer program product comprising a computer readable medium (media) having instructions stored thereon/in that, when executed (e.g., by a processor), cause the executing device to perform the methods, techniques, or embodiments described herein, the computer readable medium comprising instructions for performing various steps of the methods, techniques, or embodiments described herein. The computer readable medium may comprise a non-transitory computer readable medium. The computer readable medium may comprise a storage medium having instructions stored thereon/in which may be used to control, or cause, a computer to perform any of the processes of an embodiment. The storage medium may include, without limitation, any type of disk including floppy disks, mini disks (MDs), optical disks, DVDs, CD-ROMs, micro-drives, and magneto-optical disks, ROMs, RAMs, EPROMs, EEPROMs, DRAMs, VRAMs, flash memory devices (including flash cards), flash arrays, magnetic or optical cards, nanosystems (including molecular memory ICs), RAID devices, remote data storage/archive/warehousing, or any other type of media or device suitable for storing instructions and/or data thereon/in.

Stored on any one of the computer readable medium (media), some embodiments include software instructions for controlling both the hardware of the general purpose or specialized computer or microprocessor, and for enabling the computer or microprocessor to interact with a human user and/or other mechanism using the results of an embodiment. Such software may include without limitation device drivers, operating systems, and user applications. Ultimately, such computer readable media further includes software instructions for performing embodiments described herein. Included in the programming (software) of the general-purpose/specialized computer or microprocessor are software modules for implementing some embodiments.

The various illustrative logical blocks, modules, and circuits described in connection with the embodiments disclosed herein may be implemented or performed with a general-purpose processing device , a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processing device may be a microprocessor, but in the alternative, the processor may be any conventional processor, controller, microcontroller, or state machine. A processing device may also be implemented as a combination of computing devices, e.g., a combination of a DSP and a microprocessor, a plurality of microprocessors, one or more microprocessors in conjunction with a DSP core, or any other such configuration

Aspects of the methods disclosed herein may be performed in the operation of such processing devices. The order of the blocks presented in the figures described above can be varied—for example, some of the blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation and are not meant to be limiting.

While the present subject matter has been described in detail with respect to specific examples thereof, it will be appreciated that those skilled in the art, upon attaining an understanding of the foregoing may readily produce alterations to, variations of, and equivalents to such aspects and examples. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A method, comprising:
receiving, at a storage system, a set of notification rules from a partner computing system, the set of notification rules defining a notification filter specifying which of a plurality of storage access requests from one or more client computing systems to forward to the partner computing system;
responsive to verifying that the set of notification rules adhere to a storage rule language syntax, storing the set of event notification rules within a rule set repository accessible by the storage system; and
upon receiving a storage access request from one of the one or more client computing systems, comparing the storage access request against the notification filter by executing the set of notification rules to forward the storage access request to the partner computing system or allow the storage access request.

2. The method of claim 1, wherein executing the set of notification rules comprises: responsive to determining that the storage access request satisfies all of the notification rules, forwarding the storage access request to the partner computing system.

3. The method of claim 1, wherein executing the set of notification rules comprises: responsive to determining that the storage access request does not satisfy one or more of the notification rules, allowing the storage access request.

4. The method of claim 1, wherein the set of notification rules specify to forward the storage access request if the storage access request includes a specific internet protocol address identifying a particular one of the one or more client devices.

5. The method of claim 1, wherein the set of event notification rules specify to forward the storage access request if the storage access request includes a specific user identifier identifying a specific user or user group.

6. The method of claim 1, wherein the set of event notification rules specify to forward the storage access request if the storage access request comprises a file operation that will increase a size of a file hosted by the storage system by an amount greater than a threshold value.

7. The method of claim 1, wherein the set of event notification rules specify to forward the storage access request if the storage access request comprises a set attribute operation.

8. The method of claim 1, wherein the set of event notification rules specify to forward the storage access request if the storage access request comprises a set attribute operation for a file hosted by the storage system within a specified subdirectory.

9. A non-transitory computer-readable medium having stored thereon instructions for performing a method comprising machine executable code which when executed by at least one machine, causes the machine to:
receive, at a storage system, a set of notification rules from a partner computing system, the set of notification rules defining a notification filter specifying which of a plurality of storage access requests from one or more client computing systems to forward to the partner computing system;
responsive to verifying that the set of notification rules adhere to a storage rule language syntax, store the set of event notification rules within a rule set repository accessible by the storage system; and
upon receiving a storage access request from one of the one or more client computing systems, compare the storage access request against the notification filter by executing the set of notification rules to forward the storage access request to the partner computing system or allow the storage access request.

10. The non-transitory computer-readable medium of claim 9, wherein executing the set of notification rules comprises: responsive to determining that the storage access request satisfies all of the notification rules, forwarding the storage access request to the partner computing system.

11. The non-transitory computer-readable medium of claim 9, wherein executing the set of notification rules comprises: responsive to determining that the storage access request does not satisfy one or more of the notification rules, allowing the storage access request.

12. The non-transitory computer-readable medium of claim 9, wherein the set of notification rules specify to forward the storage access request if the storage access request includes a specific internet protocol address identifying a particular one of the one or more client devices.

13. The non-transitory computer-readable medium of claim 9, wherein the set of event notification rules specify to forward the storage access request if the storage access request includes a specific user identifier identifying a specific user or user group.

14. The non-transitory computer-readable medium of claim 9, wherein the set of event notification rules specify to forward the storage access request if the storage access request comprises a file operation that will increase a size of a file hosted by the storage system by an amount greater than a threshold value.

15. The non-transitory computer-readable medium of claim 9, wherein the set of event notification rules specify to forward the storage access request if the storage access request comprises a set attribute operation.

16. The non-transitory computer-readable medium of claim 9, wherein the set of event notification rules specify to forward the storage access request if the storage access request comprises a set attribute operation for a file hosted by the storage system within a specified subdirectory.

17. A storage system, comprising:
a processor device; and
a memory device including program code stored thereon, wherein the program code, upon execution by the processor device, performs operations comprising:
receiving, at a storage system, a set of notification rules from a partner computing system, the set of notification rules defining a notification filter specifying which of a plurality of storage access requests from one or more client computing systems to forward to the partner computing system;
responsive to verifying that the set of notification rules adhere to a storage rule language syntax, storing the set of event notification rules within a rule set repository accessible by the storage system; and
upon receiving a storage access request from one of the one or more client computing systems, comparing the storage access request against the notification filter by executing the set of notification rules to forward the storage access request to the partner computing system or allow the storage access request.

18. The storage system of claim 17, wherein executing the set of notification rules comprises: responsive to determining that the storage access request satisfies all of the notification rules, forwarding the storage access request to the partner computing system.

19. The storage system of claim 17, wherein executing the set of notification rules comprises: responsive to determining that the storage access request does not satisfy one or more of the notification rules, allowing the storage access request.

20. The storage system of claim 17, wherein the set of notification rules specify to forward the storage access request if the storage access request includes a specific internet protocol address identifying a particular one of the one or more client devices.
